(19) United States
(12) Patent Application Publication
(10) Pub. No.: US 2024/0032688 A1
(43) Pub. Date: Feb. 1, 2024

(54) USED PACKAGING BOX ORGANIZING FRAME

(71) Applicant: Morris&Co Co.,Ltd., Chungcheongbuk-do (KR)

(72) Inventor: BORA JUNG, Seoul (KR)

(21) Appl. No.: 18/216,819

(22) Filed: Jun. 30, 2023

(30) Foreign Application Priority Data
Jul. 27, 2022 (KR) 10-2022-0092916

(51) Int. Cl. A47B 47/00; A47B 47/02; A47B 47/04

(52) U.S. Cl. CPC A47B 47/0058; A47B 47/027; A47B 47/047

(57) ABSTRACT

Provided is a used packaging box organizing frame including a front frame located at a front to prevent used packaging boxes from falling in a front direction, a rear frame located at a rear spaced apart from the front frame to prevent the used packaging boxes from falling in a rear direction, and connection pipes configured to connect the front frame and the rear frame and support lower portions of the used packaging boxes to be located on a horizontal surface spaced apart from the ground, wherein the front and rear frames include pipes and connection members having insertion holes into which ends of the pipes are inserted. The pipes are formed by being inserted into the insertion holes of the connection members. The connection pipes include an outer pipe with a large diameter, and an inner pipe with a small diameter slidably inserted into the outer pipe.

### CROSS REFERENCE TO RELATED APPLICATION

The present application claims priority to Korean Patent Application No. 10-2022-0092916, filed Jul. 27, 2022, the entire contents of which is incorporated herein for all purposes by this reference.

### BACKGROUND OF THE INVENTION

### 1. Field of the Invention

The present disclosure relates to a used packaging box organizing frame and, more particularly, to a used packaging box organizing frame for storing folded packaging boxes after use neatly and for easy bundling and handling.

### 2. Description of Related Art

In recent years, especially since the outbreak of COVID-19, the number of cases where products are delivered by courier is increasing at home. Accordingly, the amount of empty used packaging boxes discarded after product delivery is rapidly increasing.

These used packaging boxes are disposed at the entrance of one's house and recovered for recycling when the boxes reach a predetermined amount.

Yet, the used packaging boxes standing at the entrance or the like easily fall over, and the fallen boxes take up a large space and spoil aesthetics.

Moreover, in order to collect used packaging boxes that are upright or overturned, it is necessary to tie the boxes with a string, but it is not easy to tie the boxes by passing the string under the disorganized boxes of various sizes.

Accordingly, there is a demand for the development of a technology that allows multiple used packaging boxes to be stored neatly to improve aesthetics and to be easily bundled and collected.

### Documents of Related Art

(Patent Document 0001) Korean Patent No. 10-1181888 (registered Sep. 5, 2012)

### SUMMARY OF THE INVENTION

Accordingly, the present disclosure has been made keeping in mind the above problems occurring in the related art, and the present disclosure is intended to provide a used packaging box organizing frame that neatly stores multiple used packaging boxes to improve aesthetics and, at the same time, allows the boxes to be easily bundled and collected.

In addition, an objective of the present disclosure is to provide a used packaging box organizing frame that is easy to move, ship, store, etc. by making pipes and connection members constituting the frame separate from each other.

In addition, an objective of the present disclosure is to provide a used packaging box organizing frame that features easy assembly as the frame is assembled by inserting the separated pipes into the connection members.

In addition, an objective of the present disclosure is to provide a used packaging box organizing frame that can be applied even when the number of used packaging boxes is large since the distance between a front frame and a rear frame is adjustable.

In addition, an objective of the present disclosure is to provide a used packaging box organizing frame that allows easy tying of used packaging boxes with a string since a drum on which the string is wound is rotatably installed on the frame.

In order to achieve the above objective, according to an embodiment of the present disclosure, there is provided a used packaging box organizing frame, including: a front frame located at a front to prevent used packaging boxes from falling in a front direction; a rear frame located at a rear spaced apart from the front frame to prevent the used packaging boxes from falling in a rear direction; and connection pipes configured to connect the front frame and the rear frame and support lower portions of the used packaging boxes to be located on a horizontal surface spaced apart from the ground, wherein the used packaging boxes stacked on the connection pipes while being between the front frame and the rear frame may be easily tied by winding central parts thereof with a string.

The front frame and the rear frame may include pipes and connection members having insertion holes into which ends of the pipes are inserted, wherein the pipes may be formed by being inserted into the insertion holes of the connection members.

The connection pipes may be inserted into the insertion holes of the connection members facing each other of the front frame and the rear frame.

Each of the front frame and the rear frame may include a second connection pipe that is a pipe connecting a left part and a right part thereof, wherein the second connection pipe may be located lower than the connection pipes, so that a string may be easily passed between lower sides of the used packaging boxes and the second connection pipes to wrap around and tie the used packaging boxes.

A drum on which the string is wound may be rotatably installed in the second connection pipe so as to be easily used when necessary.

The connection pipes may include an outer pipe with a large diameter, and an inner pipe with a small diameter slidably inserted into the outer pipe, wherein the inner pipe may adjust a distance between the front frame and the rear frame while sliding in and out of the outer pipe.

An elastic member installed between the front frame and the rear frame may further be included, wherein the elastic member may press the inner pipe to be inserted into the outer pipe in order to narrow the distance between the front frame and the rear frame.

The elastic member may be installed at a position where the elastic member does not contact the used packaging boxes.

Some of the pipes and the insertion holes of the connection members into which the some of the pipes are inserted may be formed in a polygonal shape to prevent mutual rotation.

According to the present disclosure, it is possible to neatly store multiple used packaging boxes to improve aesthetics and, at the same time, easily bundle and collect the boxes.

In addition, by making pipes and connection members constituting the frame separate from each other, it is easy to move, ship, store, etc.

In addition, easy assembly is possible as the frame is assembled by inserting the separated pipes into the connection members.

In addition, since the distance between a front frame and a rear frame is adjustable, it can be applied even when the number of used packaging boxes is large.

In addition, since a drum on which a string is wound is rotatably installed on the frame, used packaging boxes can be easily tied together with the string.

### BRIEF DESCRIPTION OF THE DRAWINGS

The above and other objectives, features, and other advantages of the present disclosure will be more clearly understood from the following detailed description when taken in conjunction with the accompanying drawings, in which:

FIG. 1 is a perspective view of a used packaging box organizing frame according to an embodiment of the present disclosure;

FIG. 2 is an exploded perspective view of the used packaging box organizing frame according to the embodiment of the present disclosure;

FIG. 3 is a view showing a state in which a drum is installed in the used packaging box organizing frame according to the embodiment of the present disclosure;

FIG. 4 is a view showing a state in which some pipes of the used packaging box organizing frame according to the embodiment of the present disclosure and insertion holes into which the pipes are inserted are formed in a polygonal shape;

FIG. 5 is a front view of the used packaging box organizing frame according to the embodiment of the present disclosure;

FIG. 6 is a side view of the used packaging box organizing frame according to the embodiment of the present disclosure; and

FIG. 7 is a view showing the use of the used packaging box organizing frame according to the embodiment of the present disclosure.

### DETAILED DESCRIPTION OF THE INVENTION

Hereinafter, preferred embodiments of the present disclosure will be described in detail with reference to exemplary drawings. In assigning reference numerals to components of each drawing, the same components are to have the same numerals as much as possible even if they are displayed on different drawings. In addition, in describing the embodiments of the present disclosure, if it is determined that a detailed description of a related known configuration or function hinders understanding of an embodiment of the present disclosure, the detailed description will be omitted.

Furthermore, in describing the components of the embodiment of the present disclosure, terms such as first, second, A, B, (a), (b) may be used. These terms are only used to distinguish the component from other components, and the nature or order of the corresponding component is not limited by the term. When a component is described as being “connected”, “coupled”, or “linked” to the other component, that component may be directly connected or linked to the other component, but another component may be interposed therebetween to be “connected”, “coupled”, or “linked”.

Hereinafter, a used packaging box organizing frame according to an embodiment of the present disclosure will be described in detail with reference to the drawings.

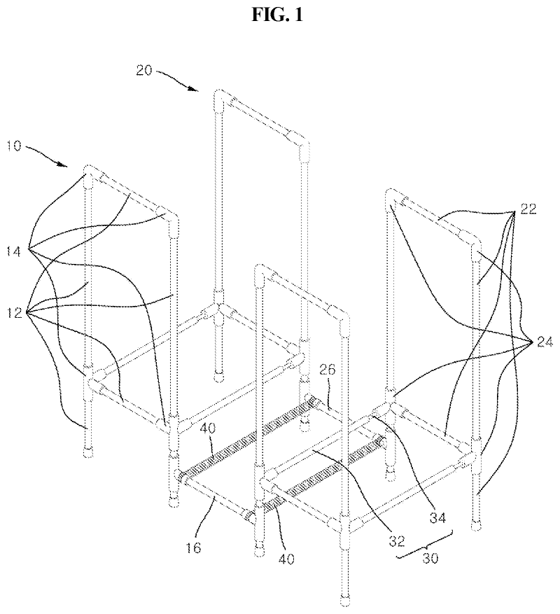

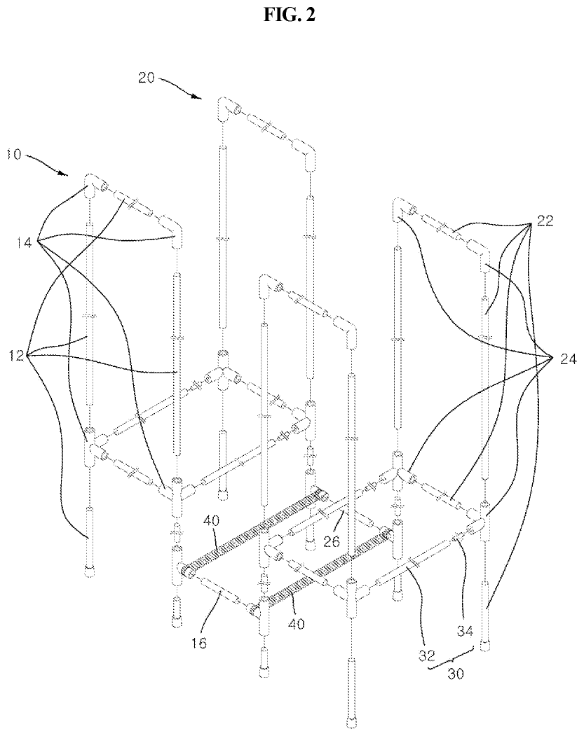

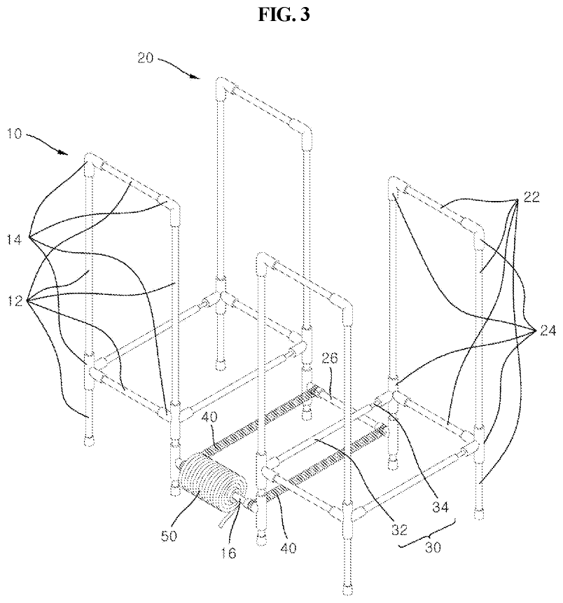

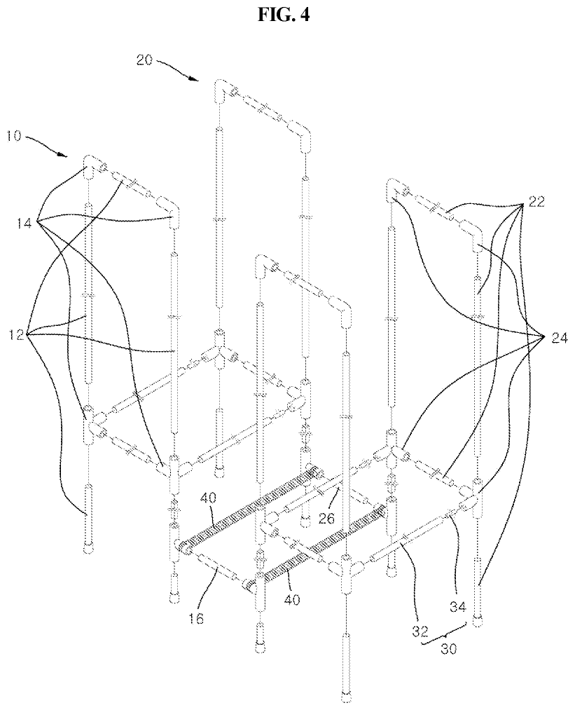

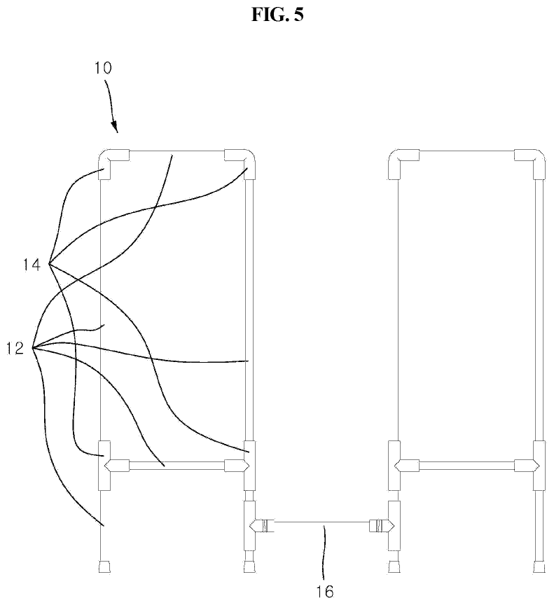

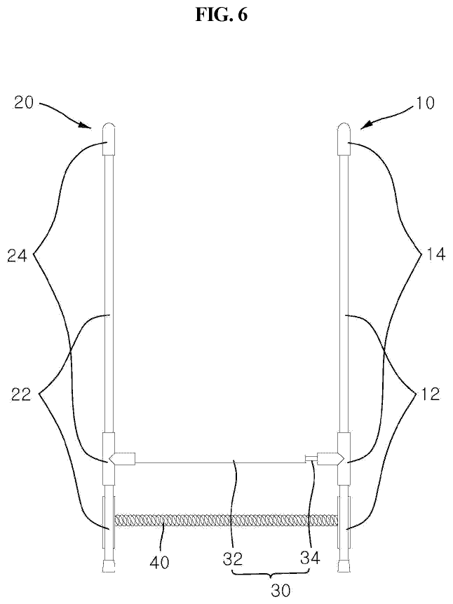

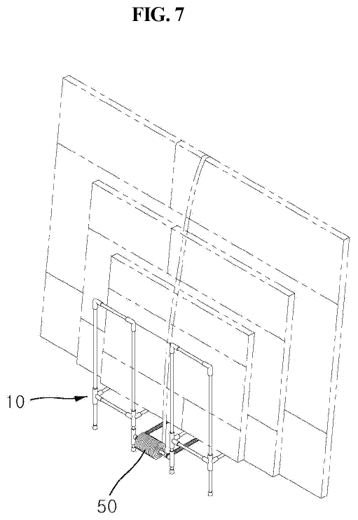

FIG. 1 is a perspective view of a used packaging box organizing frame according to an embodiment of the present disclosure; FIG. 2 is an exploded perspective view of the used packaging box organizing frame according to the embodiment of the present disclosure; FIG. 3 is a view showing a state in which a drum is installed in the used packaging box organizing frame according to the embodiment of the present disclosure; FIG. 4 is a view showing a state in which some pipes of the used packaging box organizing frame according to the embodiment of the present disclosure and insertion holes into which the pipes are inserted are formed in a polygonal shape; FIG. 5 is a front view of the used packaging box organizing frame according to the embodiment of the present disclosure; FIG. 6 is a side view of the used packaging box organizing frame according to the embodiment of the present disclosure; and FIG. 7 is a view showing the use of the used packaging box organizing frame according to the embodiment of the present disclosure.

The used packaging box organizing frame according to an embodiment of the present disclosure may include: a front frame 10 located at the front to prevent used packaging boxes from falling in the front direction; a rear frame 20 located at the rear spaced apart from the front frame 10 to prevent the used packaging boxes from falling in the rear direction; and connection pipes 30 connecting the front frame 10 and the rear frame 20 and supporting the lower portions of the used packaging boxes to be located on a horizontal surface spaced apart from the ground.

The used packaging boxes may be mounted and stored while being overlapped in the front-back direction on the connection pipes 30 while being between the front frame 10 and the rear frame 20. In addition, the stacked used packaging boxes are spaced apart from the ground or wall at the bottom and front and back sides thereof so as to be easily tied with a string and moved.

The front frame 10 and the rear frame 20 include pipes 12 and 22 and connection members 14 and 24 having insertion holes into which ends of the pipes 12 and 22 are inserted, and the pipes 12 and 22 may be formed by being inserted into the insertion holes of the connection members 14 and 24. The pipes 12 and 22 are provided in a straight line shape, etc., and the connection members 14 and 24 may be provided in a straight line shape, a ¬ shape, an ├ shape, a modified ├ shape (a shape further including an additional aim extending in a direction perpendicular to all three arms at a position where the three arms of the ├ shape are in contact, see FIG. 1, etc.), and the like.

The pipes 12 and 22 may be prepared by simply cutting the pre-manufactured straight pipes 12 and 22 to the required length. The connection members 14 and 24 may be prepared by forming in advance a straight line shape, a ¬ shape, an ├ shape, and a modified ├ shape.

The present embodiment may be easily assembled by inserting the ends of the pipes 12 and 22 into the insertion holes of the connection members 14 and 2 after preparing the straight line shaped pipes 12 and 22 having the same or different lengths and the connection members 14 and 24 such as straight line shaped and ¬ shaped. The present embodiment may be easily assembled by opening the package at the location of use after shipping or transporting the pipes 12 and 22 and the connection members 14 and 24 in a separated state. The present embodiment has a small volume by packaging in a separate state, so it is easy to ship or move, may be easily unpacked and assembled by anyone, and may be separated after use and conveniently stored in a small space.

It is appropriate that the cross sections of the pipes 12 and 22 are circular, but square, triangular, etc. are also acceptable. The circular shape is advantageous in that the pre-manufactured pipes 12, 22 may be used. In addition, the pipes 12 and 22 are suitably hollow with an empty inside, but a solid type with a filled inside is also acceptable. The hollow type saves materials, is light in weight, and easy to handle. As for the material of the pipes 12 and 22, steel, stainless steel, etc. are appropriate, but plastic or the like is also possible as long as the required strength is ensured.

For the material of the connection members 14 and 24, silicone is suitable, but steel, stainless steel, plastic, etc. are also acceptable. Silicone has good adhesion with the pipes 12 and 22 and thus has excellent bonding strength.

The connection pipes 30 may be inserted into the insertion holes of the connection members 14 and 24 of the front frame 10 and the rear frame 20 facing each other. That is, since the connection pipes 30 are located on a horizontal plane spaced apart from the ground, the lower portions of the overlapping used packaging boxes are located on a horizontal plane so that the boxes may be stored without slipping. The connection pipes 30 do not need to be far apart from the ground. When the connection pipes 30 are far apart from the ground, the center of gravity of the boxes is high and the boxes may easily collapse. It is appropriate if the distance between the connection pipes 30 and lower second connection pipes 16 and 26 to be described later is enough to allow a string to pass through or a hand to enter.

Each of the front frame 10 and the rear frame 20 is largely divided into a left part and a right part, and may include the second connection pipes 16 and 26 that are pipes connecting the left part and the right part. The second connection pipes 16 and 26 may be located lower than the connection pipes 30. Accordingly, by using the space between the used packaging boxes mounted on the connection pipes 30 and the second connection pipes 16 and 26, the string may be easily passed through with a hand or the like to tie the used packaging boxes. One or more second connection pipes 16 and 26 may be installed on each of the front frame 10 and the rear frame 20, and the second connection pipes 16 and 26 may be located lower than the connection pipes 30.

A drum 50 on which the string is wound may be rotatably installed on the second connection pipes 16 and 26. This string may be released from the drum 50 and used to easily bind the used packaging boxes. In addition, since the drum 50 is installed in the second connection pipes 16 and 26, there is no fear of loss. It is advantageous that the second connection pipes 16 and 26 are installed on the lower side as much as possible, but it is preferable that the height at which the drum 50 is installed is secured. As the string, it is also possible to use one in which the string itself is wound in a cylindrical shape without the drum 50.

The connection pipe 30 may include an outer pipe with a large diameter 32, and an inner pipe 34 having a small diameter slidably inserted into the outer pipe 32. The inner pipe 34 may adjust the distance between the front frame 10 and the rear frame 20 while sliding in and out of the outer pipe 32. Thus, the present disclosure may be applied even when the number of used packaging boxes is large.

An elastic member 40 installed between the front frame 10 and the rear frame 20 may be further included. As the elastic member 40, a spring, rubber band, etc. may be used. The elastic member 40 presses the inner pipe 34 to be inserted into the outer pipe 32, thereby narrowing the distance between the front frame 10 and the rear frame 20. When there are many used packaging boxes, the elastic member 40 is stretched and the inner pipe 34 is pulled out from the outer pipe 32 to accommodate the used packaging boxes.

The elastic member 40 may be installed at a position where it does not contact the stacked used packaging boxes. For example, the elastic members 40 may be coupled to the connection members 14 and 24 on both sides into which the second connection pipes 16 and 26 are inserted. As shown in the drawing, the elastic member 40 may be installed in a horizontal portion or a vertical portion of the connection member 14 or 24 into which the second connection pipe 16 or 26 is inserted. In addition, the elastic members 40 may be installed on the pipes 12 and 22 other than the connection members 14 and 24. However, it is preferable that the elastic member 40 is installed lower than the used packaging boxes so as not to be affected by the used packaging boxes.

Some of the pipes 12 and 22 and the insertion holes of the connection members 14 and 24 into which the pipes 12 and 22 are inserted may be formed in a polygonal shape such as a square or a triangle to prevent mutual rotation. For example, by forming the pipes 12 and 22 vertically inserted into the upper side of the connection members 14 and 24 into which the second connection pipes 16 and 26 are inserted, and the insertion holes of the connection members 14 and 24 into which the pipes 12 and 22 are inserted into squares, triangles, etc., rotation of the left and right parts of the front frame 10 and the rear frame 20 may be prevented.

In the above, even though all the components constituting the embodiment of the present disclosure have been described as being combined or operated in combination, the present disclosure is not necessarily limited to this embodiment. That is, within the scope of the objectives of the present disclosure, all of the components may be configured or operated by selectively combining one or more of the components. In addition, terms such as “include”, “comprise”, and “have” mean that the corresponding component may be present, therefore, it should be interpreted as being able to further include other components rather than excluding other components. All terms, including technical or scientific terms, have the same meaning as commonly understood by a person of ordinary skill in the art to which the present disclosure belongs, unless defined otherwise. Commonly used terms, such as terms defined in a dictionary, should be interpreted as consistent with the contextual meaning of the related technology, and are not to be construed in an idealized or overly formal sense unless explicitly defined herein.

Although exemplary embodiments of the present disclosure have been described for illustrative purposes, a person of ordinary skill in the art to which the present disclosure belongs will appreciate that various modifications, additions and substitutions are possible, without departing from the scope and spirit of the disclosure. Therefore, exemplary embodiments of the present disclosure have not been described for limiting purposes. Accordingly, the scope of the disclosure is not to be limited by the above embodiments but by the claims and the equivalents thereof.

What is claimed is:

1. A used packaging box organizing frame, comprising:
a front frame located at a front to prevent used packaging boxes from falling in a front direction;
a rear frame located at a rear spaced apart from the front frame to prevent the used packaging boxes from falling in a rear direction; and
connection pipes configured to connect the front frame and the rear frame and support lower portions of the used packaging boxes to be located on a horizontal surface spaced apart from the ground,
wherein the used packaging boxes stacked on the connection pipes while being between the front frame and the rear frame may be easily tied by winding central parts thereof with a string.

2. The used packaging box organizing frame of claim 1, wherein the front frame and the rear frame comprise pipes and connection members having insertion holes into which ends of the pipes are inserted,
wherein the pipes are formed by being inserted into the insertion holes of the connection members.

3. The used packaging box organizing frame of claim 2, wherein the connection pipes are inserted into the insertion holes of the connection members facing each other of the front frame and the rear frame.

4. The used packaging box organizing frame of claim 2, wherein each of the front frame and the rear frame comprises a second connection pipe that is a pipe connecting a left part and a right part thereof,
wherein the second connection pipe is located lower than the connection pipes, so that a string may be easily passed between lower sides of the used packaging boxes and the second connection pipes to wrap around and tie the used packaging boxes.

5. The used packaging box organizing frame of claim 4, wherein a drum on which the string is wound is rotatably installed in the second connection pipe so as to be easily used when necessary.

6. The used packaging box organizing frame of claim 1, wherein the connection pipes comprise an outer pipe with a large diameter, and an inner pipe with a small diameter slidably inserted into the outer pipe,
wherein the inner pipe adjusts a distance between the front frame and the rear frame while sliding in and out of the outer pipe.

7. The used packaging box organizing frame of claim 6, further comprising:
an elastic member installed between the front frame and the rear frame,
wherein the elastic member presses the inner pipe to be inserted into the outer pipe in order to narrow the distance between the front frame and the rear frame.

8. The used packaging box organizing frame of claim 7, wherein the elastic member is installed at a position where the elastic member does not contact the used packaging boxes.

9. The used packaging box organizing frame of claim 2, wherein some of the pipes and the insertion holes of the connection members into which the some of the pipes are inserted are formed in a polygonal shape to prevent mutual rotation.
